(19) United States
(12) Patent Application Publication
(10) Pub. No.: US 2025/0383907 A1
(43) Pub. Date: Dec. 18, 2025

(54) VIRTUAL MACHINE EXECUTION WITH HETEROGENOUS HOST AND VIRTUAL MACHINE INSTRUCTION SET ARCHITECTURES

(71) Applicant: Synopsys, Inc., Sunnyvale, CA (US)

(72) Inventors: Simon Schöning, Aachen (DE); Thomas Michael Philipp, Meerbusch (DE); Dietmar Petras, Stolberg (DE)

(21) Appl. No.: 18/745,454

(22) Filed: Jun. 17, 2024

(51) Int. Cl. G06F 9/455

(52) U.S. Cl. CPC G06F 9/45558; G06F 2009/45587

(57) ABSTRACT

A method includes: executing, on a host computer including a host processor and host memory, a hypervisor managing a virtual machine including a virtual processor and virtual machine memory, the virtual machine executing a guest program stored in the virtual machine memory, the guest program including machine instructions; disabling, by the hypervisor, execute permissions on a first page of the virtual machine memory; and handling, by the hypervisor, a first abort triggered when the virtual processor executes an instruction in the first page of the virtual machine memory having an execute permission disabled including: replacing, by the hypervisor, one or more instructions in the first page of the virtual machine memory; disabling read and write permissions and enabling an execute permission in a first entry of a page table corresponding to the first page of the virtual machine memory; and resuming execution of the guest program on the virtual processor.

### TECHNICAL FIELD

The present disclosure relates to virtualization of computer systems, including hypervisors managing the execution of virtual machines.

### BACKGROUND

Hardware virtualization or platform virtualization refers to using a host computer system or host machine to execute or run a virtual machine that virtualizes a real computer system. Software executed in a virtual machine is separated from the underlying hardware resources of the host machine.

The above information disclosed in this Background section is only for enhancement of understanding of the background of the invention and therefore it may contain information that does not constitute prior art.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A is a block diagram depicting a host computer system executing a hypervisor managing a virtual machine according to one embodiment of the present disclosure.

FIG. 1B is a schematic depiction of a two-stage address translation including a first stage from guest virtual address space to intermediate physical address space and a second stage from intermediate physical address space to physical address space.

FIGS. 2A and 2B are block diagrams illustrating privilege levels or protection rings of different code running on a computer system, including code running within guest virtual machines according to embodiments of the present disclosure.

FIG. 3 is a flowchart depicting a method for replacing instructions and restoring data based on setting permissions of portions of memory according to one embodiment of the present disclosure.

FIG. 4A is a schematic diagram illustrating the replacement of instructions for execution and reverting the replacement on subsequent read or write, according to one embodiment of the present disclosure, where a breakpoint instruction (BRK) is used as one example replacement.

FIG. 4B is a schematic diagram illustrating the replacement of instructions for execution on a page and executing a single step of an instruction due to a read or write in the same page, according to one embodiment of the present disclosure.

FIG. 5 is a flowchart depicting a method for replacing instructions and restoring data based on setting permissions of portions of memory according to one embodiment of the present disclosure.

FIG. 6 illustrates an example of permissions set in intermediate physical address space for two pages of memory before exiting a first application and after starting a second application according to one embodiment of the present disclosure.

FIG. 7 is a flowchart depicting a method for replacing instructions and restoring data based on setting permissions of portions of memory in a virtual platform with multiple virtual processors according to one embodiment of the present disclosure.

FIG. 8 depicts an example of three host processor cores executing threads corresponding to virtual processor cores concurrently jumping to (e.g., moving program counters to) a non-executable page according to one embodiment of the present disclosure.

FIG. 9 depicts a flowchart of various processes used during the design and manufacture of an integrated circuit in accordance with some embodiments of the present disclosure.

FIG. 10 depicts a diagram of an example computer system in which embodiments of the present disclosure may operate.

### DETAILED DESCRIPTION

Aspects of the present disclosure relate to virtual machine execution with heterogenous host and virtual machine instruction set architectures.

A virtual machine includes an executable software model that runs on a host system. The virtual machine emulates the hardware, including CPU instruction sets, memory maps, registers, and interrupts for software development. The virtual machine provides a functional representation of a desired system on which to develop software.

Computer programs include machine instructions that are executed by processors (e.g., central processing units or CPUs), where executing the machine instructions cause the processors to manipulate data to perform the functions specified by those programs. A compiler or an interpreter translates computer programs expressed in a higher-level language (e.g., human readable source code such as C, C++, JavaScript, and the like or intermediate representations such as bytecode such as Java bytecode) into machine instructions that can be executed by a processor.

An instruction set architecture (ISA) defines an instruction set of machine instructions and how a processor that implements the ISA behaves when executing those machine instructions. Different types of processors implement different ISAs. For example, many mainstream desktop, laptop, and server processors implement variants of the x86 ISA. Other families of ISAs include the ARM® architecture family of ISAs and the RISC-V® architecture family of ISAs.

Instruction set architectures evolve from one version to the next, as new features are added and old features are modified or removed. New features may be added in the form of new machine instructions. In some cases, the behavior of existing instructions is modified between different versions of the ISA, such as by changing how executing the instruction changes the state of the processor (e.g., which flags are set or which registers store data in the processor when executing a particular machine instruction).

Hardware virtualization relates to executing virtual machines running on one or more host machines, where the virtual machines execute software programs within the virtual machine environment. A hypervisor is a computer program that runs on a host machine and manages the execution of one or more virtual machines (e.g., starting, pausing, resuming, and terminating virtual machines, inspecting the state of virtual machines, and the like), where the virtual machines may be referred to as guests.

One benefit of virtualization relates to isolation of the software programs, such that errant behavior (e.g., memory leaks, data corruption bugs, malicious software, and the like) does not affect other software running on the host machine.

Another benefit of virtualization relates to the development and testing of software targeting different platforms that may run different operating systems. For example, software targeting a particular platform (e.g., smartphone, a vehicle electronic control unit, or other embedded computer system) can be developed on the host computer running a desktop operating system (a host operating system) and tested or run in a virtual machine that virtualizes the hardware of the target platform and executes software environment (e.g., smartphone operating system or Linux®) of the target mobile device. An operating system running within a virtual machine may be referred to as a guest operating system.

The virtual machine includes one or more virtual processors. When the target platform uses a target virtual processor having a different ISA than an ISA of a host processor of the host computer, then the execution of the virtual processor may need to be simulated using computer software running on the host machine. This approach generally exhibits poor performance due to the overhead of simulating the target CPU. On the other hand, when the target platform uses a virtual processor having the same ISA as a host processor of the host computer, then the guest programs running on the virtual machine can be run directly on the host processor and the virtual machine may run programs with little to no performance penalty compared to if those same programs were run directly on the host machine, with some additional overhead to model or virtualize global hardware resources (as each virtual host may assume it has sole ownership of a global hardware resource but multiple different virtual hosts may expect those global hardware resources to be in different states).

In some circumstances, it is difficult, expensive, or impossible to obtain a host processor having an identical ISA as the target processor. For example, software may be developed for a target platform that will include processors that are still in development.

Sometimes, the target processor may use a version of an ISA that is an extension of an existing ISA for which processors are readily available. For example, software may target a new version of a processor implementing a new version of an ISA, where the new ISA further includes several new machine instructions or modified versions of existing machine instructions while keeping all other machine instructions the same. If not for the new machine instructions, the existing processors implementing the older version of the ISA could execute the machine code of programs compiled for the target ISA. In some cases, these existing processors would be able to execute such programs if the new machine instructions were not used by those programs.

Accordingly, aspects of embodiments of the present disclosure describe hypervisors that execute virtual machines having virtual processors with a similar ISA as the ISA of the host processor, where some of the instructions supported by the virtual processors are unsupported by the host processor or cannot be executed by a virtual machine. In more detail, aspects of embodiments of the present disclosure relate to executing instructions that are supported by the host processor directly on the host processor and handling other, unsupported instructions or privileged instructions using the hypervisor, thereby enabling execution of the guest programs that were compiled for a different target ISA while maintaining high performance compared to full simulation of the target processor.

In some embodiments, the hypervisor detects when a virtual machine is attempting to execute a program and replaces instances of specified machine instructions (e.g., unsupported machine instructions and privileged instructions that cannot be executed by a virtual machine) within the program with machine instructions that are supported by the host processor. Aspects of embodiments relate to different types of replacements which include, but are not limited to, replacing a machine instruction that can be ignored with a no-operation (NOP or NOOP, where the processor does nothing and proceeds to the next instruction in the program), replacing an unsupported or privileged machine instruction with a breakpoint such that control of execution is returned to the hypervisor and the specific instruction can be emulated or simulated, or replacing the unsupported machine instruction or privileged machine instruction with one or more equivalent instructions. Replacing instructions according to embodiments of the present disclosure may also be applied in circumstances unrelated to the instruction set architectures of the host processor and the virtual processor, such as for observation (e.g., instrumentation or debugging) of guest software by replacing certain instructions with breakpoints or replacing function calls (e.g., with an instrumented version of the function to observe the execution of the function or an entirely different function).

Aspects of the present disclosure also relate to detecting attempts to execute a program in the virtual machine using permissions settings on portions of memory (e.g., pages of memory) allocated to the virtual machine. In more detail, some aspects, relate to removing or unsetting the execute permission on pages of memory allocated to the virtual machine causes an exception or interrupt to be raised and trapped or caught by the hypervisor. The hypervisor can then replace instructions in memory as outlined above and set the execute permission on the page to allow the virtual machine to continue execution with the replaced instructions. Further aspects of embodiments of the present disclosure relate to methods for managing read and write access to the program data, such that the replacement of machine instructions does not impact the expected operation of the program (e.g., because portions of the memory that look like machine instructions may actually be data) and because self-modifying programs and just-in-time (JIT) compilers (e.g., common with computer languages such as Java® and JavaScript®) may generate data that is later executed as program instructions.

Technical advantages of the present disclosure include, but are not limited to: increasing the performance of host computer systems executing virtual machines through a hypervisor, where a virtual processor of the virtual machine and a host processor of the host computer system have heterogenous (e.g., different) instruction set architectures; expanding the capabilities of hypervisors to emulate features and behaviors of processors that are not available to the host processor; and enabling hypervisors to simulate or emulate the execution of software programs in virtual machines that would otherwise be unable to execute privileged machine instructions (e.g., machine instructions that are only available to privileged programs, such as hypervisors and firmware or monitors) and to insert or inject debugging instructions (e.g., instrumentation) into guest programs running on the virtual machine. For example, aspects of embodiments of the present disclosure increase the efficiency emulating a virtual processor executing programs that include new instructions that extend a base instruction set architecture by selectively running instructions directly on the host processor where possible and emulating or replacing unsupported instructions, thereby enabling emulation without the overhead of a full simulation of the target virtual processor or just-in-time recompilation of the guest software into machine code executable by the host processor.

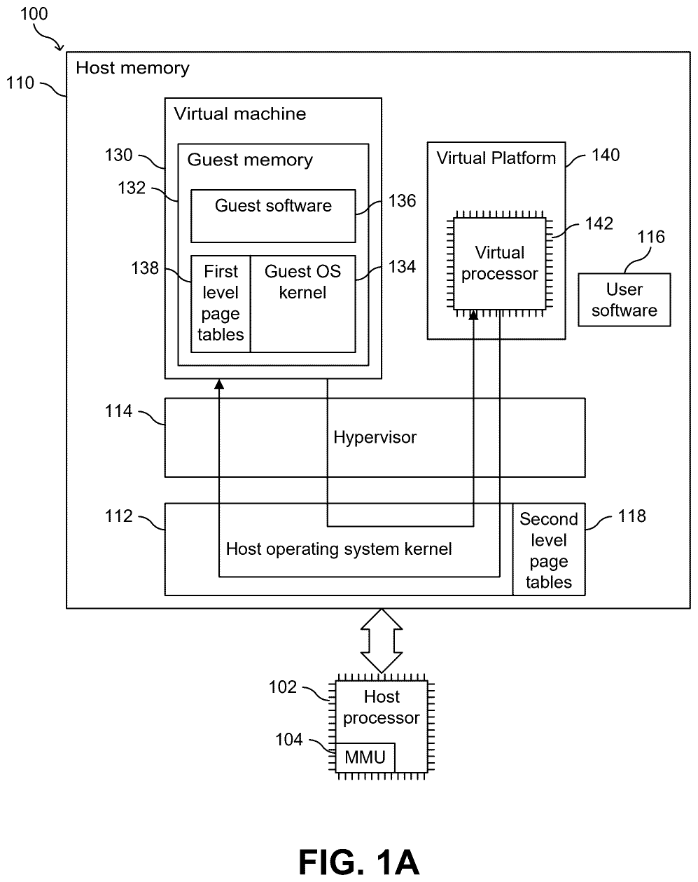

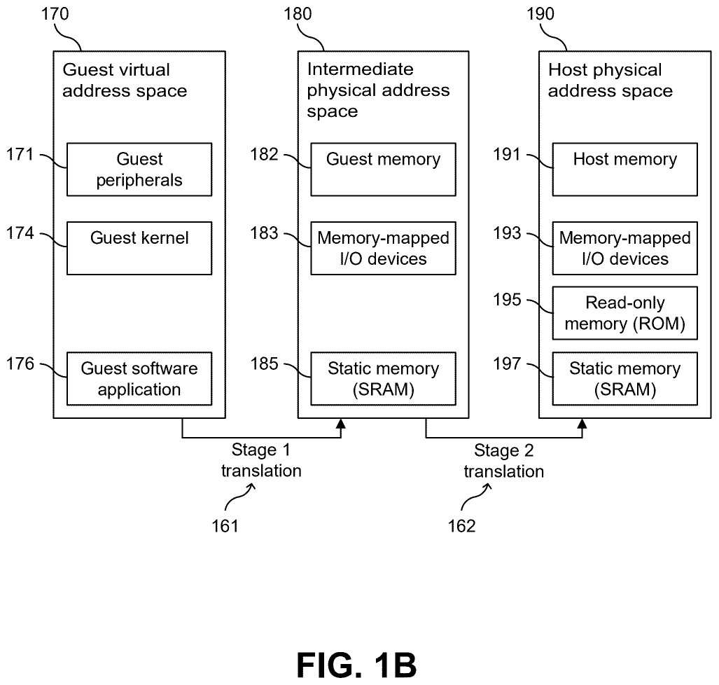

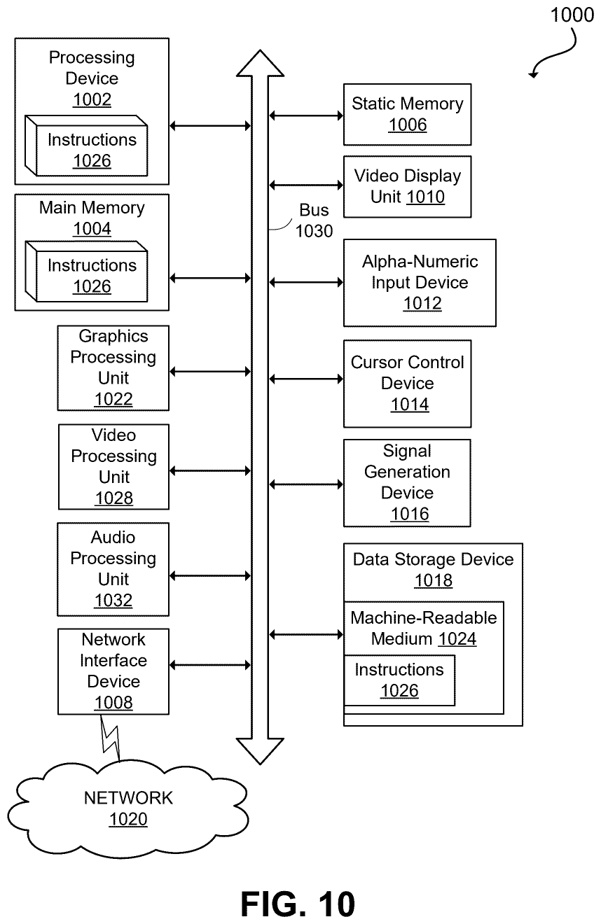

FIG. 1A is a block diagram depicting a host computer system 100 executing a hypervisor managing a virtual machine according to one embodiment of the present disclosure. The host computer system may be implemented using a computer system 1000 such as that shown and described below with respect to FIG. 10.

As shown in FIG. 1A, the host computer system 100 includes host hardware including host processor 102 (or host CPU) and host memory 110. The host memory 110 stores computer program instructions that, when executed by the host processor 102, causes the host processor to implement various aspects of embodiments of the present disclosure. In the example shown in FIG. 1A, the host memory 110 stores a host operating system kernel 112, a hypervisor 114, user software 116, and a second level page table 118.

The host processor 102 may implement an instruction set architecture (ISA). The host operating system kernel 112 and the hypervisor 114 may be stored in host memory 110 as machine instructions of the ISA of the host processor 102, such that program instructions of the host operating system and the hypervisor are executable by the host processor 102.

The hypervisor 114 is shown in FIG. 1A as managing a virtual machine instance 130. A virtual machine is a virtualized computer system, where a given execution of a virtual machine may be referred to as an instance of that virtual machine. A virtual machine instance 130 may be represented in the host memory 110 of the host computer system 100. The virtual machine instance 130 in the host memory 110 may include virtual machine memory or guest memory 132 and may interact with a virtual platform 140 which includes virtual hardware such as a target processor or guest processor or virtual processor 142. The data associated with the virtual processor 142 may include information such as the states of various portions of the virtual processor 142, such as values stored in register files and states of flags of the virtual processor 142. The virtual platform 140 may also include information about virtualized peripherals connected to the virtual machine (e.g., consoles, display devices, input and output devices, data storage devices, and the like). The guest memory 132 of the virtual machine instance 130 may store a guest operating system kernel 134 and may also store guest software 136. FIG. 1A further shows that the guest memory 132 stores a guest page table or first level page table 138.

As noted above, hardware virtualization can be used to test software portions of computer systems targeting hardware platforms that may not yet exist or that might otherwise be difficult to obtain. For example, the guest operating system kernel 134 and/or the guest software 136 may be compiled for a target instruction set architecture that differs from the instruction set architecture implemented by the host processor 102. The ISA of the host processor 102 may be referred to herein as a host ISA to distinguish it from the ISA of the virtual processor 142, which may be referred to as a target ISA.

The target ISA may include one or more machine instructions that are unsupported by the host processor 102, because those unsupported machine instructions are either non-existent in the host ISA or because the unsupported machine instructions operate differently in the target ISA than in the host ISA.

To enable testing of a guest operating system kernel 134 and/or guest software 136, the virtual platform 140 implements a virtual processor 142 that supports the target ISA, such that the virtual machine instance 130 can execute the guest operating system kernel 134 and/or the guest software 136 compiled for the target ISA.

A hypervisor 114 according to various embodiments of the present disclosure provides mechanisms to improve the performance of the virtual processor 142 in executing the guest operating system kernel 134 and/or the store guest software 136 in the virtual machine instance 130. The hypervisor 114 may run directly on the host processor 102 (e.g., a bare-metal hypervisor), may run as a software program that relies on the host operating system kernel 112 to manage resources, or combinations thereof (e.g., where portions of the functionality of the hypervisor 114 are integrated into the host operating system kernel 112).

In more detail, some aspects of embodiments of the present disclosure relate to modifications of software and hardware systems controlling the operation of memory access permissions and address translation through the second level page table 118 and the guest page table or first level page table 138, as will be described in more detail below.

The term virtual memory is a separate concept from virtualization of computer systems and refers to a memory management technique. In the example of FIG. 1A, the host operating system kernel 112, using a combination of software and hardware (such as a memory management unit that may be integrated into the host processor 102), maps virtual memory addresses used by a program (such as user software 116, the hypervisor 114, and the virtual machine instance 130) into physical addresses in the host memory 110. The second level page table 118 stores these translations between virtual addresses and physical addresses, and a memory management unit (MMU) 104 of the host processor 102 is configured to translate a given virtual address into a physical address by performing a page walk through the second level page table 118.

Similarly, the guest operating system kernel 134 provides guest software 136 running within virtual machine instance 130 with virtual addresses that map to an intermediate physical address space that is sometimes referred to as a guest physical address space. This guest physical address refers to a physical address within the virtual machine instance 130, but because the virtual machine instance 130 is a computer program running within the host computer system 100, the guest physical address is an intermediate physical address in the context of the host computer system 100 that is translated by the second level page tables 118.

This means that two stages of translation are performed when translating virtual addresses for guest software 136 running in the virtual machine. FIG. 1B is a schematic depiction of a two-stage address translation including a stage 1 translation 161 using the guest page tables (first level page table 138) to map memory addresses from a guest virtual address space 170 to an intermediate physical address space 180 and a stage 2 translation 162 using the second level page tables 118 to map memory addresses from the intermediate physical address space 180 to a physical address space or host physical address space 190 of the host computer system 100. In the example of FIG. 1B, the guest virtual address space 170 may have portions (e.g., ranges of addresses) that are assigned to memory mapped peripherals (shown as guest peripherals 171), the guest kernel 174 (e.g., the guest operating system kernel 134), and guest software applications 176 (e.g., guest software 136). The intermediate physical address space refers to the physical memory of the virtual machine instance 130 and therefore includes a region labeled guest memory 182 corresponding to the guest memory 132 of the virtual machine instance 130, as well as memory-mapped input/output devices 183 of the virtual machine instance 130 (e.g., hardware accelerators, attached storage, network interfaces, and the like), and static memory 185. The host physical address space 190 corresponds to the physical addresses of the host computer system 100, and therefore includes host memory addresses 191 corresponding to physical addresses of host memory 110, memory-mapped input/output devices 193, read-only memory (ROM) 195, and static memory (SRAM) 197.

Accordingly, aspects of embodiments of the present disclosure relate executing guest software 136 and/or guest operating system kernel 134 compiled with machine code targeting a virtual processor 142 with a different instruction set architecture (a target ISA) different from a host ISA of a host processor 102. These aspects include modifying the behavior of existing instructions as they affect the state of the virtual platform 140 and/or emulating privileged instructions and new instructions of the target ISA that extend the base ISA such that the privileged instructions and unsupported instructions in the software executed by the virtual machine instance 130 are emulated by the virtual platform 140 using the host processor 102.

In some embodiments, the emulation of extended or modified instructions includes using a memory management unit of the host processor 102 to detect and control access to instructions and data in the guest memory 132 to modify and/or replace unsupported instructions and/or privileged instructions. In some aspects of embodiments, the memory management unit sets access permissions (e.g., read, write, and execute permissions) on the portions of memory associated with the guest memory 132 (e.g., the region mapped to guest memory 182) to intercept attempts to execute code in region of the guest virtual address space corresponding to the guest kernel 174 and/or guest software applications 176. In some embodiments, the permissions are set per page of memory, although embodiments of the present disclosure are not limited thereto. The read (R), write (W), and execute (X) permissions may be identified as a collection of three permissions. For example, a RW-permission on a page of memory indicates that the page can be read from and written to, but code on that page is not executable. As another example, a --X permission on a page indicates that code on the page can be executed, but the page cannot be read from or written to. A --- permission indicates that no access is allowed. A RWX permission indicates that the page can be read from, written to, and that machine code in the page can be executed. A program counter (PC) is a register in a processor (e.g., the virtual processor 142) that contains the address of an instruction that is to be executed next or that is currently being executed, where the PC is updated with the address of the next instruction to be executed after the current instruction is executed.

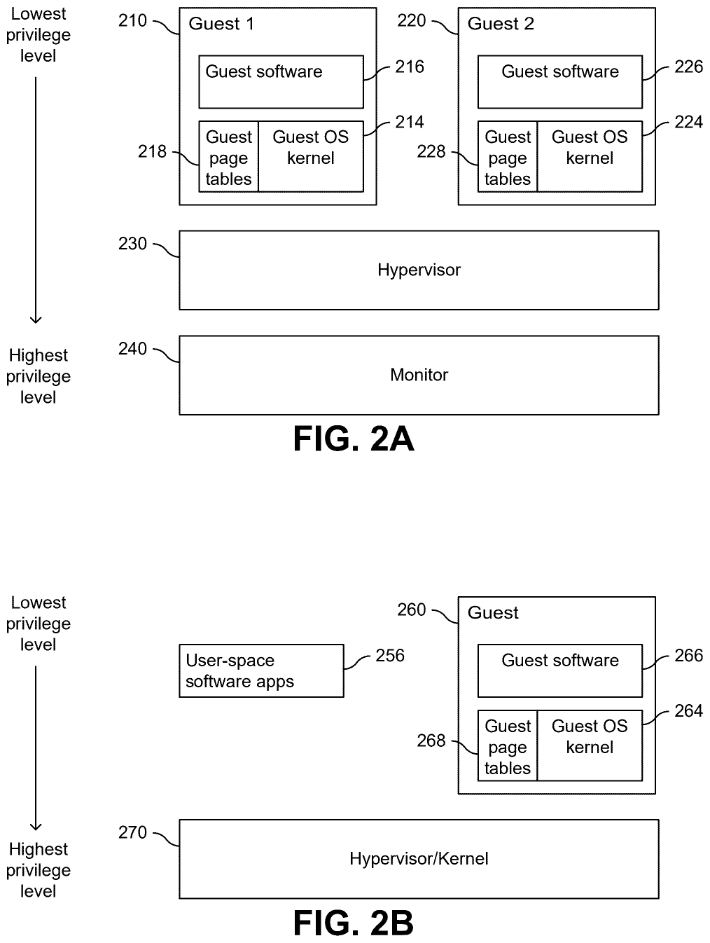

FIGS. 2A and 2B are block diagrams illustrating privilege levels or protection rings of different code running on a computer system, including code running within guest virtual machines according to embodiments of the present disclosure. In the example shown in FIG. 2A, a host processor 102 implements up to four exception levels (which may be referred to in some ISAs from lowest privileged exception level 0 or EL0 having the fewest access permissions through highest privileged exception level 3 or EL3 having the most access permissions) or protection rings (which may be referred to in some ISAs from lowest privileged ring 3 having the fewest access permissions to most privileged ring 0 having the most access permissions). In this example of FIG. 2A, a hypervisor 230 runs directly on a host processor without an additional operating system managing access to hardware. User-space applications, such as guest software 216 and 226 respectively running within a first virtual machine 210 and a second virtual machine 220 may run at the lowest privileged level. Guest operating system kernels 214 and 224 respectively running within the first virtual machine 210 and the second virtual machine 220 may run at a higher level of privilege than the guest software 216 and 226. A hypervisor 230 may run at an even higher level of privilege than the guest operating system kernels 214 and 224. The highest privilege level is used to execute a secure monitor 240, such as within a firmware of the system. (As shown in FIG. 2A, each of the first virtual machine 210 and the second virtual machine 220 has a corresponding first guest page table 218 and a corresponding second guest page table 228, respectively, which maintains translations between virtual memory addresses seen by guest software 216 and 226 and the guest operating system kernels 214 and 224, respectively, and guest physical addresses.)

FIG. 2B shows another example where a hypervisor is integrated into an operating system kernel 270. User-space software applications 256 may run on the kernel 270 (e.g., use application programing interfaces provided by the kernel 270 to access hardware devices). A user-space software application among the user-space software applications 256 may also be used to manage the hypervisor, such as for launching, pausing, resuming, and shutting down virtual machines such as guest virtual machine 260. The guest virtual machine 260 may run a guest operating system kernel 264 and guest software 266 and may also store guest page tables 268 for translating between virtual memory addresses as presented to guest software 266 and guest physical addresses as visible to the guest operating system kernel 264. As seen in FIG. 2B, the user-space software applications 256 and the guest software 266 are run at the lowest privilege level, the guest operating system kernel 264 is run at a next higher privilege level, and the hypervisor/kernel 270 is run at the highest privilege level (in the example of FIG. 2B, there is no higher privilege level shown).

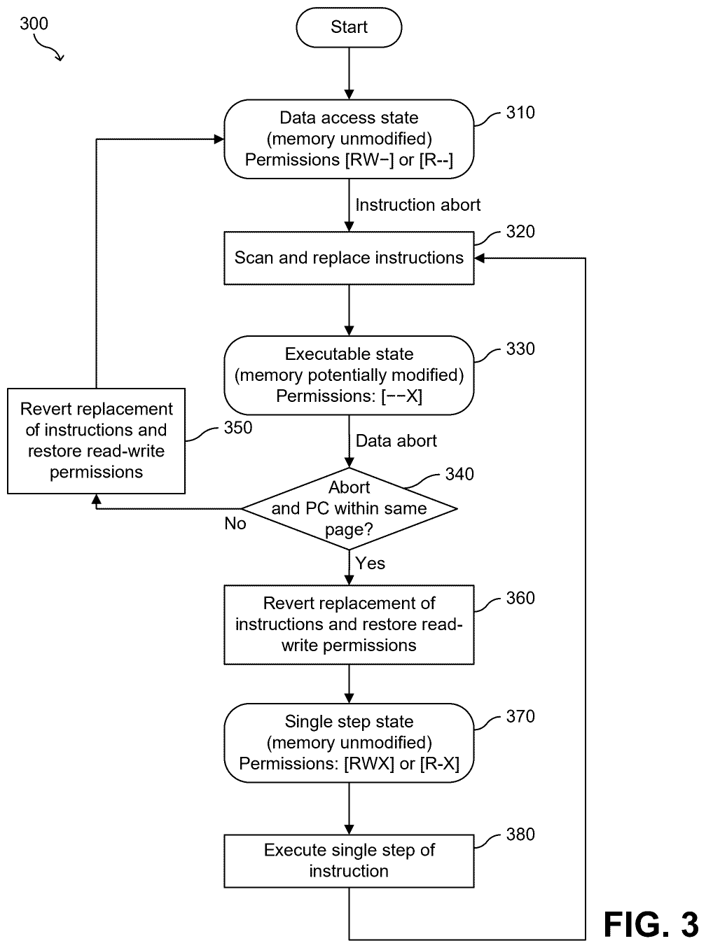

FIG. 3 is a flowchart depicting a method 300 for replacing instructions (e.g., unsupported instructions and/or privileged instructions) and restoring data based on setting permissions of portions of memory according to one embodiment of the present disclosure. The method 300 may be implemented using a processing circuit such as the host processor 102 shown in FIG. 1 and/or the processing device 1002 shown in FIG. 10, such as within a processor core of the host processor 102 or processing device 1002.

As noted above, aspects of embodiments of the present disclosure relate to setting permissions on portions of memory to monitor and to control the execution of software running in a virtual machine instance 130. In the example embodiments described below, a page of memory will be used as the unit of memory at which permissions are set. However, embodiments of the present disclosure are not limited thereto. In this example, permissions are set at the stage 2 translation 162 at the level of the intermediate physical address space 180 (also referred to as guest physical address space).

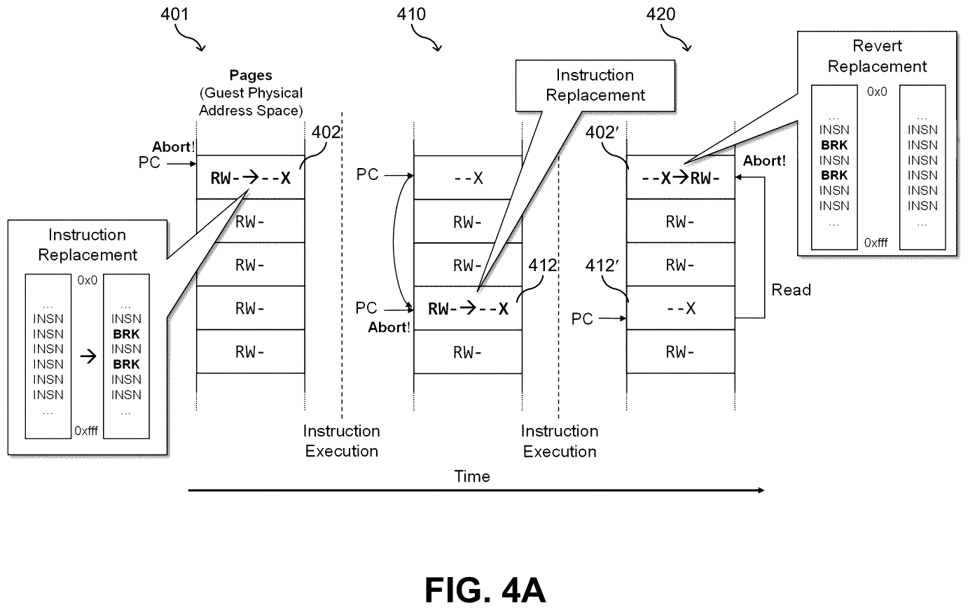

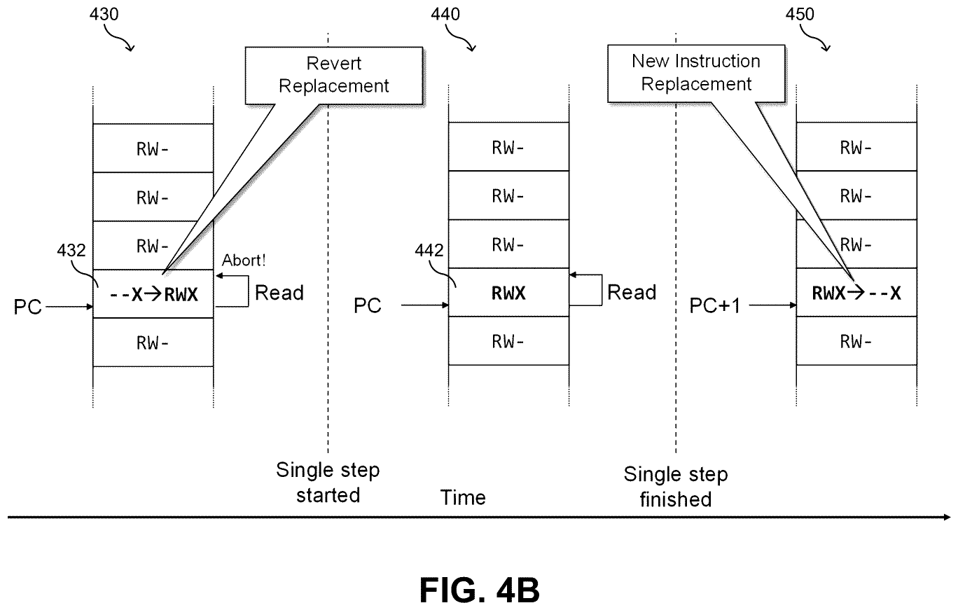

FIG. 4A is a schematic diagram illustrating the replacement of instructions for execution and reverting the replacement on subsequent read or write, according to one embodiment of the present disclosure, where a breakpoint instruction (BRK) is used as one example replacement.

As shown in FIG. 3, the method 300 starts when a virtual machine instance 130 is initialized and before execution of the software of interest begins (e.g., before booting the virtual machine instance 130). Initially, as shown at 401 of FIG. 4A, pages of guest memory 132 that are accessed (e.g., written to) by the virtual machine instance 130 are marked in a data access state at 310 with read-write permissions set and with the execute permission unset or disabled (in other words, with execution permission disabled, denoted as [RW-] for pages designated as being readable and writable). Some pages of guest memory 132 may be mapped to read-only devices (e.g., a read-only memory or ROM) and therefore the write permissions would not be enabled on those pages (e.g., with only read permission enabled, denoted as [R--]). Some pages of guest memory 132 may also be designated (e.g., at the virtual hardware level of the virtual platform 140) as being nonexecutable (e.g., mapped to read-only memory, peripheral devices, and the like) accordingly, in some embodiments of the present disclosure, disabling the execute permission on the page has no effect because the page is designated as nonexecutable at the hardware level (e.g., the execute permission is already disabled). In some embodiments, the table entries of the second level page table 118 are initialized at the first abort during execution of the virtual machine instance 130 (where an abort may be triggered when accessing a page that does not have a corresponding entry in the second level page table 118). When the virtual machine instance 130 attempts to execute an instruction at the program counter (PC) in a first page 402 of memory that has the execute permission disabled, an instruction abort is generated (e.g., an interrupt or exception or trap occurs). In particular, the program counter associated with the guest program being executed by the virtual processor 142 identifies a memory address in a page of memory in the guest physical address space. The attempted execution of the instruction at the address identified by the program counter triggers the instruction abort on a page of memory because that page does not have execute permissions. Because the permissions are set at the intermediate physical address space 180, this exception is generated at a higher privilege level than that of the guest operating system kernel 134, such that the exception is raised to the hypervisor 114 (and not caught by the guest operating system kernel 134).

At 320, when handing the instruction abort, an abort handler of the hypervisor 114 (e.g., a processing circuit executing software handling the interrupt or trap or exception) scans the first page 402 of memory on which the instruction abort occurred and replaces instructions (e.g., unsupported instructions and/or privileged instructions) with other instructions (e.g., instructions that are supported by the host ISA of the host processor 102). As noted above, some pages of guest memory 132 may be designated (e.g., at the virtual hardware level of the virtual platform 140) as being nonexecutable. Accordingly, in some embodiments of the present disclosure, when handling the instruction abort, the hypervisor determines whether the page is designated as nonexecutable and, if so, returns control to the virtual machine instance 130 with an instruction abort (e.g., indicating that the guest program attempted to execute an instruction in a nonexecutable page) instead of performing the scanning and replacing of instructions in the page at 320. As shown in FIG. 4A, the first page 402 of memory is shown as having values stored in addresses with offsets from 0x0 to 0xfff. FIG. 4A shows that two unsupported instructions (labeled INSN) in the first page 402 are replaced with different instructions, here breakpoint instructions (BRK).

In some embodiments, the hypervisor 114 maintains an instruction replacement mapping indicating how instructions found in the code are to be replaced with different instructions. (For example, replacing unsupported instructions with functionally equivalent instructions or breakpoints for emulating the instructions and replacing privileged instructions with breakpoints such that the operation of the privileged instruction can be emulated by the hypervisor 114.) In some embodiments, the instruction replacement mapping is represented as a lookup table that maps from original instructions (e.g., instructions unsupported by the host ISA) to replacement instructions (e.g., instructions supported by the host ISA). In some embodiments, the instruction replacement mapping is stored in the compiled code of the hypervisor, such in branches of a switch statement or a pattern matching feature. In some embodiments, the hypervisor 114 stores the instructions were originally present in the code before replacement, such that the page of memory can be restored to its state before replacement of instructions.

While FIG. 4A shows as example of replacing some instructions with breakpoint instructions, embodiments of the present disclosure are not limited thereto and other substitutions can be made, such as replacing an instruction with a functionally equivalent instruction or with a no-operation instruction (NOOP).

As one concrete example, an extension to an ISA may include a security feature such as pointer authentication. Such a security feature may be used to mitigate attacks that intentionally modify pointers (e.g., a return address of a function call) to obtain execution control over a processor. For example, a hash or code can be computed using a secret key and stored with the pointer at the start of the function call. When returning from the function, the return address is verified (by confirming that the code still matches) before updating the program counter with the return address.

In a case of testing guest software on a virtual processor 142 with a target ISA that supports these pointer authentication instructions emulated by a host processor 102 that does not support these pointer authentication instructions, different types of substitutions may have different effects. In a case where the pointer authentication functionality is not the subject of the test (e.g., where basic functionality of the guest software is being developed and evaluated) then the pointer authentication instructions can be effectively ignored where they do not impact the control flow of the program or otherwise affect the state of the processor.

For example, pointer authentication instructions solely relating to computing and storing pointer authentication codes and solely relating to verifying the pointer authentication codes can be replaced with no-operation instructions (NOOP). On the other hand, an extended instruction that combined the functionality of a function return with a pointer authentication could not be replaced with a NOOP because the program would then continue to the next instruction in memory, instead of jumping to the stored return address. In such a case, instances of this specific instruction (combining the functionality of return and pointer authentication) may be replaced by a standard return instruction.

In some embodiments, an unsupported instruction or a privileged instruction may be replaced by a breakpoint instruction (BRK) as shown in FIG. 4A to enable emulation of these instructions and will be described in more detail below.

In many circumstances, it may be difficult or impossible to determine whether any given value stored in memory corresponds to code or data. As such, in some embodiments of the present disclosure, all values in the page matching an instruction listed for replacement in the instruction replacement table (e.g., unsupported instructions and/or privileged instructions) are replaced accordingly at 320.

At 330, the hypervisor sets the page in an executable with the read and write permissions unset or cleared and the execute permission set (denoted as [--X]). Removing the read and write permissions prevents programs from detecting the replacement of values matching instructions in the table at 520. Execution of the program then proceeds by returning control to the virtual machine instance 130. As shown in FIG. 4A, as execution continues, the program counter may jump to other pages of memory, such as shown at 410, where the program counter has jumped to a second page in memory 412. Here, the first page 402 is left in the execute state [--X] even though the PC is no longer in that page. The instruction abort results in a similar flow through FIG. 3, resulting in the replacement of instructions in the second page 412 before returning control to the virtual machine instance 130 to continue execution.

As shown in FIG. 4A, when the program (or another program) attempts, at 420, to read data from the first page 402′, which was still in the execute state [--X], thereby resulting in a data abort. As shown in FIG. 3, at 340, the abort handler of the hypervisor 114 determines whether the data abort and the program counter are within the same page. As shown in the example of FIG. 4A, the data abort occurred in the first page 402′ and the program counter pointed to an address in the second page 412′. Therefore, the hypervisor 114 would determine that they are not in the same page and proceed with, at 350, reverting the replacement of instructions in the first page 402′ and by restoring the prior read and write permissions on the page (e.g., [RW-] in the case of a page that is designated readable and writable or [R--] in the case of a page that is designated read-only). As shown in FIG. 4A, this includes replacing the breakpoints that replaced some instructions with the original values of those instructions before setting the page to the data access state at 310 and then returning control to the virtual machine instance 130. This allows the program to continue interacting with (e.g., reading from and writing to) the first page 402′ as if none of the values had ever been replaced by the hypervisor.

FIG. 4B is a schematic diagram illustrating the replacement of instructions for execution on a page and executing a single step of an instruction due to a read or write in the same page, according to one embodiment of the present disclosure.

In the example shown in FIG. 4B, it is assumed that at a time 430, a third page 432 is in a executable state as shown at 330 of FIG. 3 and that the current instruction identified by program counter PC involves a read or write operation (shown in FIG. 4B as a read operation) that identifies an address in the same third page 432 that the address of the program counter PC falls within. As before, this attempted read triggers a data abort because the third page 432 is in the executable state, with read and write permissions disabled. As such, at 340, the abort handler of the hypervisor 114 determines that the data abort and the PC are in the same page and proceeds to revert the replacement of instructions and restoring prior read and write permissions as in the data access state 310 at 360. (In some embodiments, the reversion of the replacement of instructions and restoration of read-write permissions at 350 and 360 shown in FIG. 3 is performed in response to the data abort and before determining whether the abort and PC are within the same page at 340. In such embodiments, the flow proceeds directly to the data access state 310 if the abort and PC are in different pages or proceeds directly to the single step state at 370 in the case where the abort and the PC are in the same page.) For example, this may involve retrieving the stored information regarding the original instructions that were replaced and restoring the values in the third page 442 with those original instructions and retrieving the prior read and write permissions (e.g., RW in the case of a page designated as being readable and writable or R- in the case of a page designated as being read-only). At 370, the hypervisor 114 restores the read and write permissions on the third page 442 to a single step state (e.g., with permissions [RWX] on a page that is designated as readable and writable, and [R-X] on a page that is read-only, unless the page is designated as nonexecutable, in which case the execute permission is disabled as [RW-] or [R--], respectively) such that the instruction can be executed, and data can be read from and written to the third page 442. At 380, the hypervisor 114 proceeds with returning control to the virtual machine instance 130 to execute the single instruction identified by the program counter PC to perform the appropriate read or write to the page of memory and then taking control back from the virtual machine instance 130. In some embodiments, the execution of a single instruction is performed using a single-step feature provided by the host processor 102, where the single-step feature may be used, for example, for the self-hosted debugging of programs. After executing the single step of the instruction, the hypervisor 114 returns to scan and replace the instructions at 320 and to put the third page back into executable state [--X] at 330, as shown at 450 of FIG. 4B for the execution of the next instruction at PC+1.

In the case of a read instruction, reverting the replacement of instructions at 360 ensures that the correct data is read from memory when the single step is performed at 370 (e.g., because the value at the memory location that was read may have been replaced at 320 of FIG. 3). In the case of a write instruction, reverting the replacement of instructions and performing a subsequent scan and replace ensures that, if the written data corresponds to an unsupported instruction (such as in a case where the program being executed is has self-modifying code, is a compiler such as a just-in-time compiler for a language such as JavaScript, or the page is being reused for other purposes), it is correctly replaced at 320.

Controlling the execution of the virtual machine instance 130 to perform only a single step of the execution ensures that only the current instruction that is identified by the program counter is executed. Returning control to the virtual machine 130 with the memory page with read, write, and execute permissions enabled (RWX) and with the original values stored (without replacement of instructions) would create the possibility that the virtual machine 130 could attempt to execute an unreplaced instruction (e.g., an unsupported or privileged instruction) in that page of memory.

While FIG. 3 illustrates one approach, embodiments of the present disclosure are not limited thereto.

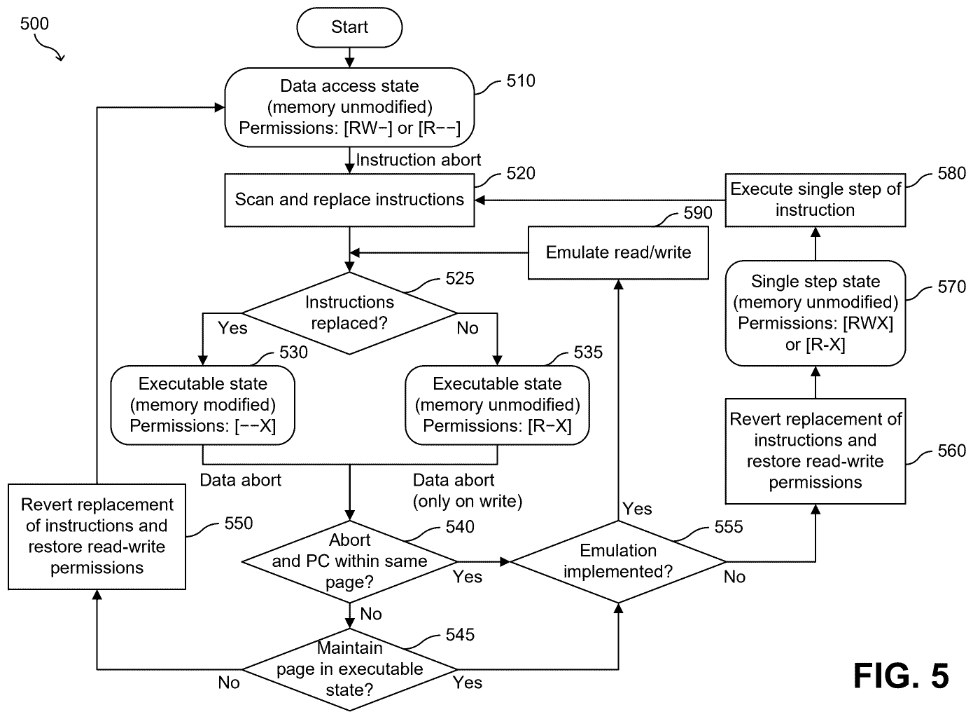

FIG. 5 is a flowchart depicting a method 500 for replacing instructions (e.g., unsupported instructions and/or privileged instructions) and restoring data based on setting permissions of portions of memory according to one embodiment of the present disclosure. The method 500 includes modifications to the method 300 described with respect to FIG. 3 to provide improved performance for read operations and write operations in some circumstances. The method 500 may be implemented using a processing circuit such as the host processor 102 shown in FIG. 1 and/or the processing device 1002 shown in FIG. 10, such as within a processor core of the host processor 102 or processing device 1002.

As shown in FIG. 5, the method 500 starts when a virtual machine instance 130 is initialized and before execution of the software of interest begins (e.g., before booting the virtual machine instance 130). Initially pages of guest memory 132 that are written to by the virtual machine instance 130 are marked in a data access state at 510 with read-write permissions set and with the execute permission unset (in other words, with execution permission disabled, denoted as [RW-]). Some pages of guest memory 132 may be mapped to read-only devices (e.g., a read-only memory or ROM) and therefore the write permissions would not be enabled on those pages (e.g., with only read permission enabled, denoted as [R--]). Some pages of guest memory 132 may also be designated (e.g., at the virtual hardware level of the virtual platform 140) as being nonexecutable (e.g., mapped to read-only memory, peripheral devices, and the like) accordingly, in some embodiments of the present disclosure, disabling the execute permission on the page has no effect because the page is designated as nonexecutable at the hardware level (e.g., the execute permission is already disabled). In some embodiments, the table entries of the second level page table 118 are initialized at the first abort during execution of the virtual machine instance 130 (where an abort may be triggered when accessing a page that does not have a corresponding entry in the second level page table 118).

When the virtual machine instance 130 attempts to execute an instruction at the program counter (PC) in a first page of memory that has the execute permission disabled, an instruction abort is generated (e.g., an interrupt or exception or trap occurs). At 520, when handing the instruction abort, an abort handler of the hypervisor 114 (e.g., a processing circuit executing software handling the interrupt or trap or exception) scans the first page of memory on which the instruction abort occurred and replaces unsupported instructions and/or privileged instructions with other instructions (e.g., instructions that are supported by the host ISA of the host processor 102). As noted above, some pages of guest memory 132 may be designated (e.g., at the virtual hardware level of the virtual platform 140) as being nonexecutable. Accordingly, in some embodiments of the present disclosure, when handling the instruction abort, the hypervisor determines whether the page is designated as nonexecutable and, if so, returns control to the virtual machine instance 130 with an instruction abort (e.g., indicating that the guest program attempted to execute an instruction in a nonexecutable page) instead of performing the scanning and replacing of instructions in the page at 520.

At 525, the hypervisor 114 determines whether any instructions were replaced at 520. For example, if the page of memory does not store any values that match the patterns of the unsupported and/or privileged instructions that are to be replaced, then no modifications are made to the page at 520.

In a case where modifications were made to the page, then at 530, the page is set to an executable state that indicates that the page was modified by the instruction replacement at 520, as indicated by having only the execute permission set (no read or write permissions), which is consistent with the executable state at 330 of FIG. 3.

In a case where no modifications were made to the page at 520, then at 535, the hypervisor 114 sets the page to an executable state that indicates that the page was unmodified by the instruction replacement at 520, as indicated by having read and execute permissions set (but not a write permission set). Because no modifications were made to the page by the scanning and replacement of instructions at 520, it is safe for a program to read from this memory page without a risk of reading values that were replaced. This improves the performance of executing software compiled for a target ISA different from a host ISA according to embodiments of the present disclosure because reads to these unmodified pages can proceed without triggering a data abort.

As shown in FIG. 5, when a data abort is triggered, such as by executing an instruction to read from a page in the executable state that was modified by instruction replacement or by executing an instruction to write to the page, then, at 540, the hypervisor 114 determines whether the abort and the program counter are on the same page.

In a case where the data abort occurs on a different page than the page that the program counter is pointing to, then at 545, the abort handler of the hypervisor 114 determines whether to maintain the page in an executable state at 545. The decision as to whether to maintain the page in an executable state (e.g., executable state with memory modified at 530 or executable state with memory unmodified at 535) depends on whether further instructions will be executed from the same page. If more instructions (e.g., the next instructions) will be executed from this page, then it would be more efficient to maintain the page in executable state, to avoid the overhead of scanning and replacing the instructions again at 520. On the other hand, if the next instructions to be executed will come from a different page and further data access instructions (read or write instructions) will be executed on memory addresses on this page, then it would be more efficient to transition the page to a data access state at 510 by reverting the replacement of the instructions at 550 and restoring the prior read and write permissions on the page (e.g., [RW-] in the case of a page that is designated readable and writable or [R--] in the case of a page that is designated read-only) to avoid the overhead of performing single steps or emulation of reads and writes, as discussed in more detail below.

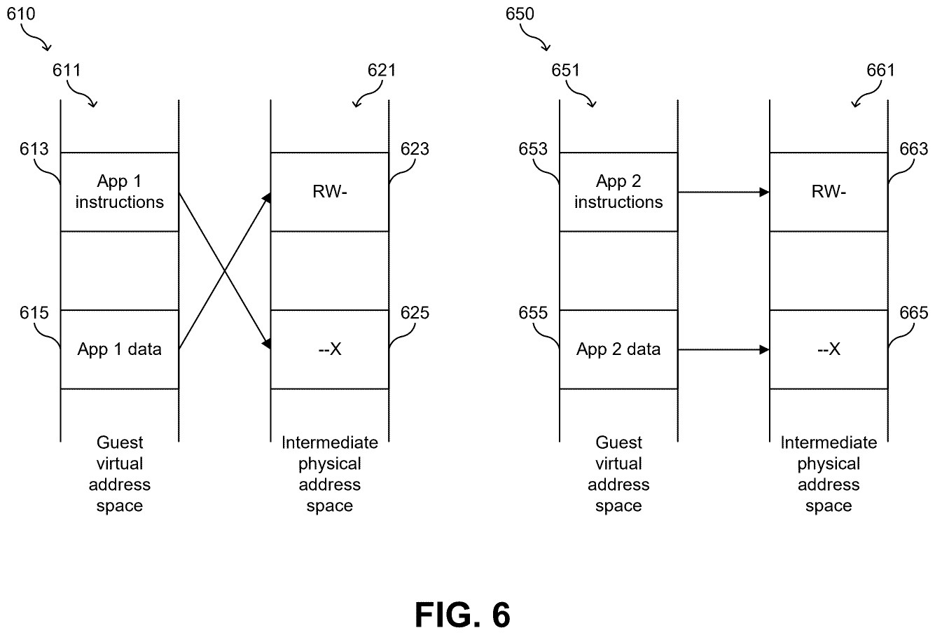

One example of a circumstance where the permissions of memory pages may be set inappropriately in intermediate physical address space occurs when one guest software application exits, and another guest software application starts. FIG. 6 illustrates an example of permissions set in intermediate physical address space for two pages of memory before exiting a first application and after starting a second application according to one embodiment of the present disclosure.

At 610, before a first guest application (App 1) exits, a first guest virtual page 613 in guest virtual address space 611 stores the instructions associated with the first application (App 1 instructions) and a second guest virtual page 615 in the guest virtual address space 611 stores the data associated with the first application (App 1 data). The second guest virtual page 615 in guest virtual address space 611 is mapped to a first intermediate physical page 623 in intermediate physical address space 621 and the first guest virtual page 613 in guest virtual address space 611 is mapped to a second intermediate physical page 625 in intermediate physical address space 621. Because the first intermediate physical page 623 stores data, its permissions are set to a data access state RW-, and because the second intermediate physical page 625 stores instructions, its permissions are set to an executable state --X.

However, after the first guest application (App 1) exits, the guest operating system kernel 134 releases the memory that was allocated to the first guest application. The freed pages of memory can then be allocated to a second guest application (App 2) which starts at 650. In this case, the first guest virtual page 653 in guest virtual address space 651 may be allocated to the instructions associated with the second application (App 2 instructions) and the second guest virtual page 655 in the guest virtual address space 651 may be allocated to data associated with the second application (App 2 data). In the example shown in FIG. 6, the first guest virtual page 653 is mapped to the first intermediate physical page 663 in intermediate physical address space 661 and the second guest virtual page 655 is mapped to the second intermediate physical 663 and the second intermediate physical page 665 may be the same intermediate physical pages as the first intermediate physical page 623 and the second intermediate physical page 625, retaining the same permissions and states as prior to termination of the first guest application. In this case, the states and permissions of the allocated memory pages in intermediate physical address space are inappropriate for what is stored there: the instructions for the second guest application are stored in a page of memory in the data access state and the data for the second guest application are stored in a page of memory in the execution state.

In some embodiments of the present disclosure, a heuristic is applied at 545 to determine whether to transition the page associated with the data abort to a data access state or to remain in an execution state. In some embodiments, the heuristic is based on the current program counter of the aborting virtual processor 142. When the program counter is pointing into the page where the data abort occurred, the page is guaranteed to contain executable code and therefore it is kept in the executable state (e.g., corresponding to the Yes branch from 545 in FIG. 5). When the program pointer points into a different page, it is assumed that the page does not contain executable code and is made non-executable (e.g., corresponding to the No branch from 545 in FIG. 5). A subsequent instruction abort would then be handled similarly for pages that were never executed or previously executable but switched back to a non-executable state.

In a case where the page is maintained in an executable state, whether because the hypervisor 114 made such a determination at 545 or because the data abort and the program counter were detected to be within the same page at 540, then at 555 the hypervisor 114 determines whether emulation is implemented for the instruction to be executed. If not, then the hypervisor 114 proceeds with reverting the replacement of instructions and restoring prior read and write permissions as in the data access state 510 at 560, transitioning the page to a single step state at 570 (e.g., enabling read, write, and execute permissions [RWX] on a page that is designated as readable and writable, and enabling read and execute permissions, but not write permission [R-X] on a page that is read-only, unless the page is designated as nonexecutable, in which case the execute permission is disabled as [RW-] or [R--], respectively), and executing a single step of the instruction at 580 (in a manner similar to those performed at 360, 370, and 380 of FIG. 3) before proceeding with scanning and replacing the instructions in the page at 520.

In a case where the hypervisor 114 determines at 555 that emulation is implemented for the instruction, then at 590 the hypervisor 114 emulates the instruction at 590 without changing the state or permissions of the memory page (e.g., while maintaining the memory page in the executable state).

In some embodiments, emulation of a read or write instruction at 590 includes updating the state of the guest memory 132 and/or the state of the virtual processor 142 in accordance with the specifications of the instruction. For example, in the case of a read instruction, a value from the guest memory 132 may be copied into a register of the virtual processor 142. In this case, the hypervisor 114 determines whether the memory address accessed by the read instruction was modified at 520 when scanning a page and replacing instructions. If the value at that location was not replaced, then the value from the guest memory 132 may be copied into the register of the virtual processor 142. If the value at that location was replaced, then the value that was saved for that location during the replacement operation is copied into the register of the virtual processor 142. The hypervisor 114 is able to perform these emulated read and write operations because it is not subject to the permissions settings set in the second level page table 118 translating from the intermediate physical address space 180 to the host physical address space 190.

In the case of a write instruction, after performing the write, the newly written data is scanned for matches with instructions to be replaced and any matching instructions are replaced in a manner like that performed on an entire page at 520.

While FIG. 5 illustrates a circumstance where emulation at 590 is performed in the case of a read or write instruction triggered by a data abort, embodiments of the present disclosure are not limited thereto. For example, as described above with respect to FIG. 4A, in some embodiments, one or more instructions (e.g., unsupported instructions and/or privileged instructions) are replaced with breakpoint instructions that return control to the hypervisor 114 such that the hypervisor can emulate the operation of the replaced instructions by updating the state of the guest memory 132 (e.g., reading and writing data to memory) and the virtual processor 142 (e.g., setting the values stored in registers and flags) in accordance with the functionality of the replaced instructions as defined in the corresponding target ISA of the virtual processor 142. For example, in various embodiments of the present disclosure, emulating an instruction at 590 includes modifying a value stored in a program counter of the virtual machine in accordance with the emulation of the instruction, before resuming execution of the guest program on the virtual processor. The types of modifications to the program counter include, but are not limited to, incrementing the program counter (e.g., to point to the next instruction in memory) or writing a different value to the program counter as specified by the emulated instruction (e.g., a conditional jump based on the value of an argument or flag, a return which results in a jump based on a saved return address, and the like).

Therefore, various aspects of embodiments of the present disclosure relate to using page permissions in an intermediate physical address space to control the execution of code compiled for a target ISA in a virtual machine instance 130 using a virtual platform 140 with a virtual processor 142 implementing the target ISA such that unsupported instructions that are not available in a host processor 102 and privileged instructions that cannot be executed by a virtual machine in a can be replaced with functionally equivalent instructions or emulated by a hypervisor.

The flowcharts of the method 300 described above with respect to FIG. 3 and the method 500 described above with respect to FIG. 5 assume single threaded access to the permissions set on the pages in the intermediate physical address space. However, race conditions may occur in multithreaded system, such as where a virtual platform 140 includes multiple virtual processors (and/or, for example, a multi-core virtual processor) operating concurrently (e.g., in parallel). For example, a virtual platform 140 with two virtual processors 142 running in parallel could try to execute code from the same page at the same time which would trigger two parallel scan and replace operations of the same page. As another example, one virtual processor might also try to read data from a page while that page is undergoing a scan and replace operation, as triggered by another virtual processor. In both cases, while scanning for and replacing unsupported instructions and/or privileged instructions, a page should not be readable because the page may have been modified, and it also should not be executable because not all replacements have been completed. As such, some aspects of embodiments of the present disclosure relate to implementing a locked state for regions of memory (e.g., memory pages) to provide synchronization of access between different virtual processors.

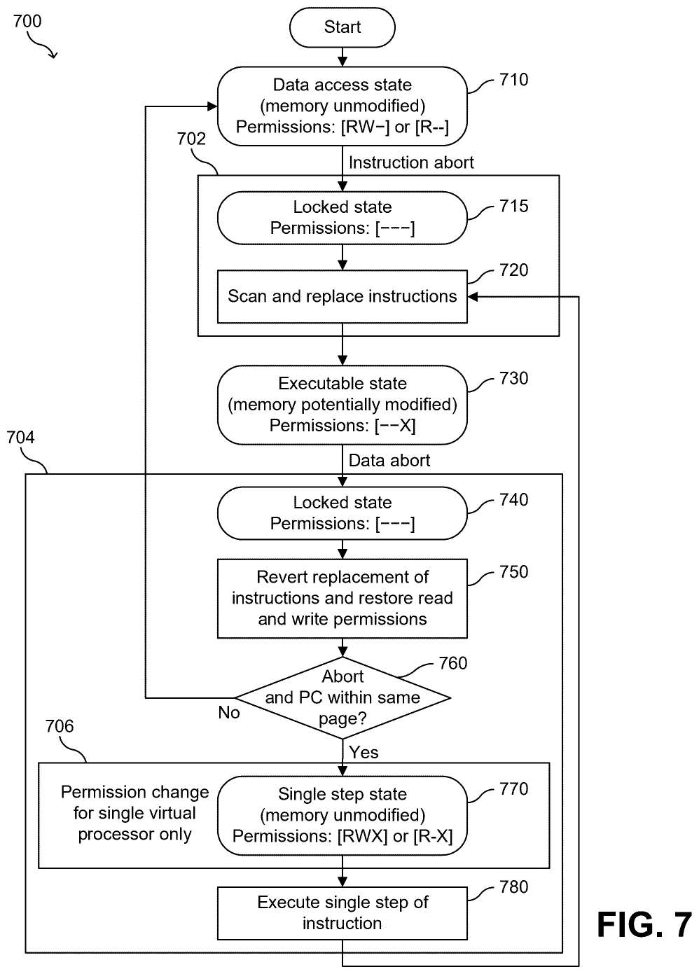

FIG. 7 is a flowchart depicting a method 700 for replacing unsupported instructions and/or privileged instructions and restoring data based on setting permissions of portions of memory in a virtual platform with multiple virtual processors according to one embodiment of the present disclosure. The method 700 includes modifications to the method 300 described with respect to FIG. 3 to provide a locked state to avoid race conditions between multiple virtual processors operating in parallel. While FIG. 7 is illustrated as a modification of the method 300 of FIG. 3, embodiments of the present disclosure are not limited thereto. For example, in some embodiments, the technique of locking pages of memory is also combined with one or more of: separating the executable state into an executable state with memory modified and an executable state with memory unmodified (as shown at 530 and 535 of FIG. 5) and/or emulation of instructions (as shown at 555 and 590 of FIG. 5). The method 700 may be implemented using a processing circuit such as the host processor 102 shown in FIG. 1 and/or the processing device 1002 shown in FIG. 10, such as within a processor core of the host processor 102 or processing device 1002.

As shown in FIG. 7, the method 700 starts when a virtual machine instance 130 is initialized and before execution of the software of interest begins (e.g., before booting the virtual machine instance 130). Initially pages of guest memory 132 that are accessed (e.g., written to) by the virtual machine instance 130 are marked in a data access state at 710 with read-write permissions set and with the execute permission unset (in other words, with execution permission disabled, denoted as [RW-]). Some pages of guest memory 132 may be mapped to read-only devices (e.g., a read-only memory or ROM) and therefore the write permissions would not be enabled on those pages (e.g., with only read permission enabled, denoted as [R--]). Some pages of guest memory 132 may also be designated (e.g., at the virtual hardware level of the virtual platform 140) as being nonexecutable (e.g., mapped to read-only memory, peripheral devices, and the like) accordingly, in some embodiments of the present disclosure, disabling the execute permission on the page has no effect because the page is designated as nonexecutable at the hardware level (e.g., the execute permission is already disabled). In some embodiments, the table entries of the second level page table 118 are initialized at the first abort during execution of the virtual machine instance 130 (where an abort may be triggered when accessing a page that does not have a corresponding entry in the second level page table 118).

When a virtual processor of the virtual machine instance 130 attempts to execute an instruction at the program counter (PC) in a first page of memory that has the execute permission disabled, an instruction abort is generated (e.g., an interrupt or exception or trap occurs). In response to detecting an instruction abort, an abort handler of the hypervisor 114 checks if the page is in the locked state 715 by determining if access permissions are disabled (e.g., because the page table entry of the second level page table 118 is invalid or by detecting that the read, write, and execute permissions all disabled or unset) and immediately returns control back to the guest when the page is locked or when the reason for the permission fault was already handled, e.g., the abort was caused by a non-executable page, but the page is already in the executable state 730 (e.g., because a different thread already triggered the transition of that page to the executable state 730). In some embodiments, when the page is locked, the execution of the virtual processor core is suspended until the lock or mutex on the page is released (e.g., access permissions are reenabled). In some embodiments, a notification is provided to suspended virtual processor cores when a lock on a page is released by another virtual processor core.

In a case where the page is not in the locked state 715, the abort handler tries to modify the page table entry (PTE) corresponding to the page using an atomic compare and exchange to disable the access permissions on the page (e.g., by setting the permissions to disable read, write, and execute permissions or by invalidating the page table entry) to put the page in the locked state 715. The atomic compare and exchange may be implemented as an instruction of the host ISA and guarantees that inspecting (comparing the value to a given value) and modifying the permissions on the page table entry or the value of the page table entry (e.g., to point to an invalid second level page or invalid host physical address) is performed atomically, meaning that no other threads concurrently compare and modify that page table entry, as indicated by the box 702 indicating that exactly one virtual processor has a lock on the page.

When the hypervisor 114 has successfully detected that the page is not in the locked state and has set the page to the locked state 715, then at 720 the hypervisor 114 scans and replaces instructions (e.g., unsupported instructions and/or privileged instructions) in the locked page with other instructions (e.g., instructions that are supported by the host ISA of the host processor 102). As noted above, because read, write, and execute permissions are all disabled on the page while in the locked state (or the second level page table 118 translates the page to an invalid host physical address), no other threads of virtual processors of the virtual platform 140 can access this page when one of the threads has the lock (or mutex) on the page. As noted above, some pages of guest memory 132 may be designated (e.g., at the virtual hardware level of the virtual platform 140) as being nonexecutable. Accordingly, in some embodiments of the present disclosure, when handling the instruction abort, the hypervisor determines whether the page is designated as nonexecutable and, if so, returns control to the virtual machine instance 130 with an instruction abort (e.g., indicating that the guest program attempted to execute an instruction in a nonexecutable page) instead of performing the scanning and replacing of instructions in the page at 720.

At 730, the hypervisor 114 releases the lock on the page by setting the page to an executable state 730. As noted above, in some embodiments, the hypervisor 114 sets the page to an executable state with memory modified state (--X) or an executable state with memory unmodified state (R-X) depending on whether any instructions were replaced at 720.

A data abort may later occur on the page of memory, such as when a write instruction or a read instruction is executed on a memory address in the page. An abort handler of the hypervisor 114 handles the abort by putting the page in the locked state 740, using an atomic compare and exchange operation as discussed above. If the atomic compare and exchange operation is successful (e.g., the abort handler detects that the page is in the executable state and successfully modifies the state to the locked state), then the thread of the hypervisor 140 has obtained a lock or mutex on the page, as indicated by the box 704, such that other virtual processors do not have access during operations while this thread has the lock 704 (e.g., at 740, 750, 760, 770, and 780 as shown in in FIG. 7).

At 750, the hypervisor 114 reverts the replacement of instructions (to restore the content of the page of memory before the scan and replace at 720) and, at 760, determines if the data abort and the program counter are in the same page. If not, then the hypervisor 114 sets the page to the data access state 710 by restoring the prior read and write permissions on the page (e.g., [RW-] in the case of a page that is designated readable and writable or [R--] in the case of a page that is designated read-only, unless the page is designated as nonexecutable, in which the execute permission is disabled as [RW-] or [R--], respectively), which releases the lock 704 on the page (e.g., releases the page from the locked state 740), such that the virtual processor can access the data on that page to execute an instruction on a different page. (As noted above, in some embodiments, the hypervisor 114 may alternatively determine whether to retain the page in executable state or locked state and emulate the data access instead of transitioning the page to the data access state 710.)

If the data abort and the program counter are in the same page, then at 770 the hypervisor performs a permission change to the single step state (e.g., read, write, and execute permissions [RWX] on a page that is designated as readable and writeable, and read and execute permissions, but not write permission [R-X] on a page that is read-only, unless the page is designated as nonexecutable, in which case the execute permission is disabled) that is visible only to the current virtual processor that is executing an instruction from and performing a data access operation (a read or write operation) on the current page.

At 780, the hypervisor controls the virtual processor to execute a single step of the current instruction, then returns to perform a scan and replacement of instructions at 720, without releasing the lock 704 on the page as seen from the other threads, and then releasing the lock or mutex by placing the page into an executable state 730, as visible to all virtual processors of the virtual platform 140.

In some embodiments, instead of placing the page in a single step state at 770 and performing a single step at 780, the data instruction that triggered the data abort may be handled by the hypervisor 114 using emulation of the instruction, in a manner like that shown in at 555 and at 590 of FIG. 5.

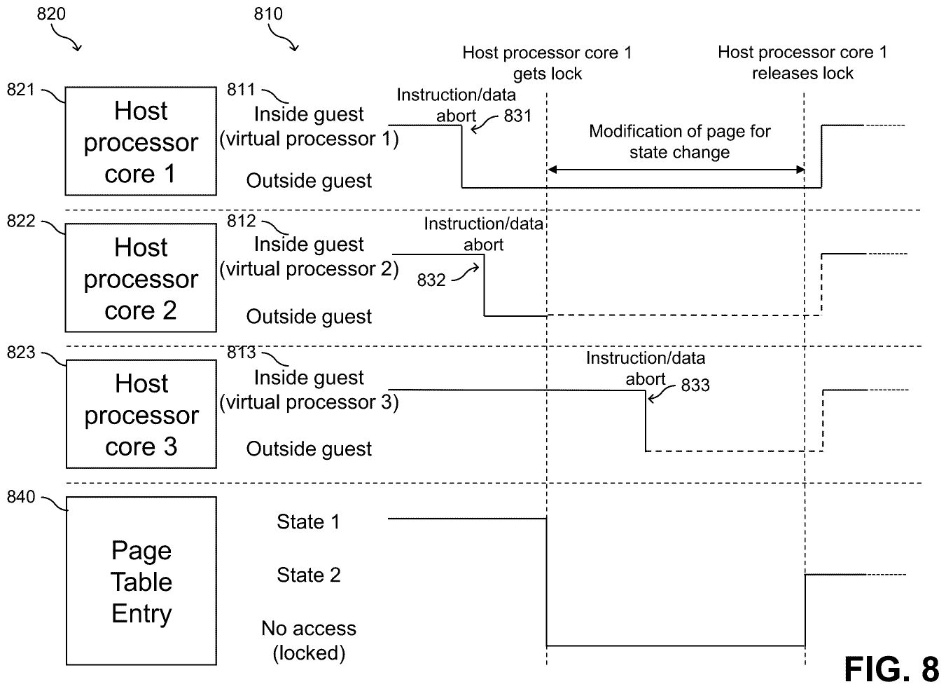

FIG. 8 depicts an example of three host processor cores executing threads corresponding to virtual processor cores concurrently jumping to (e.g., moving program counters to) a non-executable page according to one embodiment of the present disclosure. The example of FIG. 8 assumes that a virtual platform includes three virtual processors 810, including first virtual processor 811 (virtual processor 1), second virtual processor 812 (virtual processor 2), and third virtual processor 813 (virtual processor 3). Execution threads corresponding to these virtual processors may be executed by corresponding host processor cores 820, including first host processor core 821 (host processor core 1), second host processor core 822 (host processor core 2), and third host processor core 823 (host processor core 3).

In one example, all three execution threads are attempting to access a same page to execute an instruction in that page (e.g., because the program counters associated with those threads point to addresses in a same page of memory), where that page of memory is initially in a data access state (RW-). As such, the attempt to execute an instruction in that page results in an instruction abort. (A similar analysis applies in the case where the cores were attempting to read or write data to a page and the page was in an executable state.)

As shown in FIG. 8, the first host processor core 821 attempts to execute an instruction before the second host processor core 822, which triggers, respectively, first instruction abort 831 and second instruction abort 832. Because both instruction aborts 831 and 832 occur before either of the host processor cores gets the lock on the page, there is a race condition. The atomic compare and exchange instruction ensures that only one host core gets the lock on the page-in the example shown in FIG. 8, the first host processor core 821 got the lock. Accordingly, the first host processor core 821 modifies the page table entry 840 for the page to transition it from a first state (state 1, such as the data access state) to a locked state (No access) while it performs the scan and replacement of instructions in the page, and transitions the state of the page from the locked state to a second state (state 2), such as the executable state, after completing the modification of the page. The first host processor core 821 then releases the lock on the page and returns control to the first virtual processor 811 (e.g., to resume execution of the guest software). Releasing the lock on the page also allows the second host processor core 822 to detect the release and the state change and to return control to the second virtual processor 812 upon detecting that the page has been transitioned to the executable state. The third host processor core 823 in this example does not trigger an instruction abort 833 until after the first host processor core 821 locked the page. As such, the third host processor core 823 does not attempt to lock the page and, instead, waits for the page to be unlocked again to resume execution of guest software on the third virtual processor 813.

Accordingly, aspects of embodiments of the present disclosure relate to systems and methods replacing instructions of a program compiled for a target ISA that are unsupported by a host processor having a host ISA different from the target ISA or that use privileged instructions that cannot be executed by a virtual machine such that the host processor can execute a virtual machine with higher performance that a full simulation of a virtual processor implementing the target ISA. Some aspects of embodiments further relate to implementing locks or mutexes with respect to pages of memory to allow multiple threads running on one or more virtual processor cores to share memory in which values stored in the memory may have been replaced as described above.

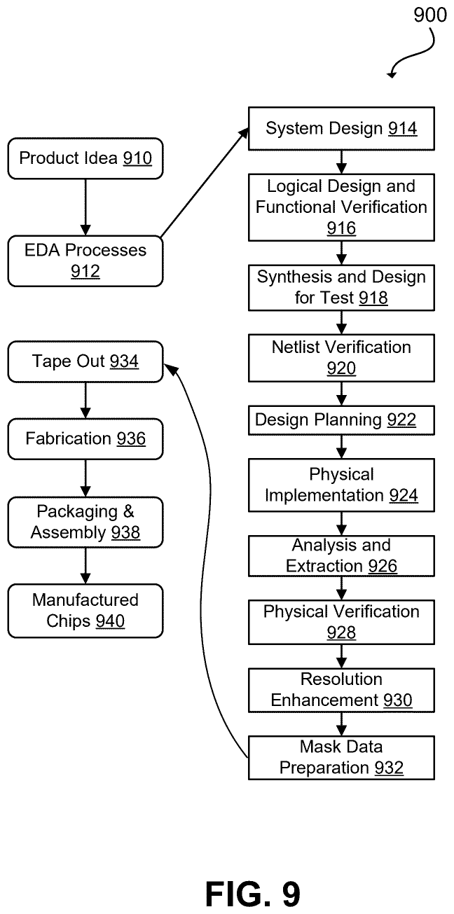

FIG. 9 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 938 are performed to produce the finished integrated circuit 940.

Specifications for a circuit or electronic structure may range from low-level transistor material layouts to high-level description languages. A high-level of representation may be used to design circuits and systems, using a hardware description language (‘HDL’) such as VHDL, Verilog, SystemVerilog, SystemC, MyHDL or Open Vera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described may be enabled by EDA products (or EDA systems).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

A storage subsystem of a computer system (such as computer system 1000 of FIG. 10) may be used to store the programs and data structures that are used by some or all of the EDA products described herein, and products used for development of cells for the library and for physical and logical design that use the library.

FIG. 10 illustrates an example machine of a computer system 1000 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer, a tablet personal computer, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1000 includes a processing device 1002, a main memory 1004 (e.g., read-only memory (ROM), flash memory, dynamic random-access memory (DRAM) such as synchronous DRAM (SDRAM), a static memory 1006 (e.g., flash memory, static random access memory (SRAM), etc.), and a data storage device 1018, which communicate with each other via a bus 1030.

Processing device 1002 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. The processing device 1002 may be configured to execute instructions 1026 for performing the operations and steps described herein.

The computer system 1000 may further include a network interface device 1008 to communicate over the network 1020. The computer system 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), a graphics processing unit 1022, a signal generation device 1016 (e.g., a speaker), graphics processing unit 1022, video processing unit 1028, and audio processing unit 1032.

The data storage device 1018 may include a machine-readable storage medium 1024 (also known as a non-transitory computer-readable medium) on which is stored one or more sets of instructions 1026 or software embodying any one or more of the methodologies or functions described herein. The instructions 1026 may also reside, completely or at least partially, within the main memory 1004 and/or within the processing device 1002 during execution thereof by the computer system 1000, the main memory 1004 and the processing device 1002 also constituting machine-readable storage media.

In some implementations, the instructions 1026 include instructions to implement functionality corresponding to the present disclosure. While the machine-readable storage medium 1024 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1002 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method includes: executing, on a host computer including a host processor and host memory, a hypervisor managing a virtual machine including a virtual processor and virtual machine memory, the virtual machine executing a guest program stored in the virtual machine memory, the guest program including machine instructions; disabling, by the hypervisor, execute permissions on a first page of the virtual machine memory; and handling, by the hypervisor, a first abort triggered when the virtual processor executes an instruction in the first page of the virtual machine memory having an execute permission disabled including: replacing, by the hypervisor, one or more instructions in the first page of the virtual machine memory; disabling read and write permissions and enabling an execute permission in a first entry of a page table corresponding to the first page of the virtual machine memory; and resuming execution of the guest program on the virtual processor.

The replacing may include replacing instances of a first instruction with a breakpoint instruction, and the method may further include emulating behavior of the first instruction in the virtual processor of the virtual machine and modifying a program counter of the virtual machine before resuming execution of the guest program on the virtual processor.

The host processor may implement a host instruction set architecture and the virtual processor implements a target instruction set architecture different from the host instruction set architecture, and the first instruction may be supported by the target instruction set architecture and unsupported by the host instruction set architecture.

The host processor may implement a host instruction set architecture and the virtual processor implements a target instruction set architecture different from the host instruction set architecture, and the first instruction may have different behavior in the host instruction set architecture than in the target instruction set architecture.

The first instruction may be a privileged instruction that is not executable by the virtual processor.

The method may further include: handling a second abort triggered after the first abort when the virtual processor executes a data access instruction to access data in the first page of the virtual machine memory, the first page of virtual machine memory having the read and write permissions disabled, the data access instruction being stored in a second page of the virtual machine memory different than the first page, including: reverting the replacement of the one or more instructions in the first page of the virtual machine memory; restoring the read and write permissions on the first page of the virtual machine memory and disabling the execute permission in the first entry of the page table corresponding to the first page of the virtual machine memory; and resuming execution of the guest program on the virtual processor.

The method may further include: handling a second abort triggered after the first abort when the virtual processor executes a data access instruction in the first page of the virtual machine memory to access data stored in the first page of the virtual machine memory, the first page of the virtual machine memory having the read and write permissions disabled, including: reverting the replacement of the one or more instructions in the first page of the virtual machine memory; restoring the read and write permissions in the first entry of the page table corresponding to the first page of the virtual machine memory; executing a single step of the execution of the guest program; scanning the first page of the virtual machine memory for the one or more instructions and replacing detected instances of instructions; disabling the read and write permissions in the first entry of the page table corresponding to the first page of the virtual machine memory; and resuming the execution of the guest program on the virtual processor.

The method may further include: handling a second abort triggered when the virtual processor executes a data access instruction; and emulating the data access instruction without changing the permissions in an entry of the page table corresponding to a page of the virtual machine memory associated with the second abort.

The method may further include: in response to determining that one or more instructions were replaced in the first page of the virtual machine memory, disabling a read permission and a write permission in the first entry of the page table corresponding to the first page of the virtual machine memory; and in response to determining that no instructions were replaced in the first page of the virtual machine memory, enabling the read permission and disabling the write permission in the first entry of the page table corresponding to the first page of the virtual machine memory.

According to one embodiment of the present disclosure, a system includes: a host memory storing instructions; and a host processor, coupled with the host memory and to execute the instructions, the instructions when executed cause the host processor to: execute a hypervisor managing a virtual machine including: a virtual processor; and a virtual machine memory, the virtual processor executing a guest program stored in the virtual machine memory, the guest program including machine instructions; disable execute permissions on a first page of the virtual machine memory; and handle, by the hypervisor, a first abort triggered when the virtual processor executes an instruction in the first page of the virtual machine memory having an execute permission disabled in a first entry of a page table corresponding to the first page of the virtual machine memory, including: scanning the first page of the virtual machine memory for one or more instructions and replacing detected instances of the one or more instructions; disabling read and write permission and enabling an execute permission in the first entry of the page table corresponding to the first page of the virtual machine memory; and resuming execution of the guest program on the virtual processor.

The host processor may include a plurality of processor cores, the virtual processor may include a plurality of virtual processor cores, and the instructions to handle the first abort may include instructions that, when executed by a host processor core of the host processor, cause the host processor core to: execute an atomic compare and exchange operation on the first entry of the page table corresponding to the first page of the virtual machine memory to disable access permissions before executing the instructions to scan the first page of the virtual machine memory.

The host memory may further store instructions that, when executed by the host processor, cause the host processor to: in response to the atomic compare and exchange operation detecting that the access permissions are already disabled, resume execution of the guest program on the virtual processor or suspend execution of the virtual processor.

The host memory may further store instructions that, when executed by the host processor, cause the host processor to: handle a second abort triggered after the first abort when a first virtual processor core of the virtual processor executes a data access instruction to access data in the first page of the virtual machine memory, the first page of the virtual machine memory having access permissions disabled by the first virtual processor core including: when the data access instruction is in a second page of the virtual machine memory different from the first page of the virtual machine memory: reverting the replacement of the one or more instructions in the first page of the virtual machine memory; restoring the read and write permissions on the first page of the virtual machine memory and disabling the execute permission in the first entry of the page table corresponding to the first page of the virtual machine memory; and resuming execution of the guest program on the virtual processor; and when the data access instruction is in the first page of the virtual machine memory: reverting the replacement of the one or more instructions in the first page of the virtual machine memory; restoring the read and write permissions in the first entry of the page table corresponding to the first page of the virtual machine memory in a manner visible only to the first virtual processor core; enabling the execute permission in the first entry of the page table corresponding to the first page of the virtual machine memory in a manner visible only to the first virtual processor core; executing a single step of the execution of the guest program; scanning the first page of the virtual machine memory for the one or more instructions in the first page of the virtual machine memory replacing detected instances of instructions; disabling the read and write permissions and enabling the execute permission in the first entry of the page table corresponding to the first page of the virtual machine memory; and resuming the execution of the guest program on the virtual processor.

The host processor may include a plurality of host processor cores, the virtual processor may include a plurality of virtual processor cores, and the host memory may further store instructions that, when executed by a host processor core of the host processor, cause the host processor core to: handle a third abort triggered after the first abort when a second virtual processor core of the virtual processor executes a second data access instruction to access data in the first page of the virtual machine memory including: executing an atomic compare and exchange operation on the first entry of the page table corresponding to the first page of the virtual machine memory to disable the access permissions; and in response to detecting that the first page of the virtual machine memory has access permissions disabled, return control to the second virtual processor core or suspend execution of the second virtual processor core.

According to one embodiment of the present disclosure, a non-transitory computer-readable medium including stored instructions, which when executed by a processor, cause the processor to: execute a hypervisor configured to manage a virtual machine including: a virtual processor; and a virtual machine memory, the virtual processor executing a guest program stored in the virtual machine memory, the guest program including machine instructions; disable execute permissions on each page of memory associated with the virtual machine memory; and handle, by the hypervisor, a first abort triggered when the virtual processor executes an instruction in a first page of the virtual machine memory having an execute permission disabled in a first entry of a page table corresponding to the first page of the virtual machine memory, including: scanning the first page of the virtual machine memory for one or more instructions and replacing detected instances of instructions; disabling read and write permissions and enabling an execute permission in the first entry of the page table corresponding to the first page of the virtual machine memory; and resuming execution of the guest program on the virtual processor.

The non-transitory computer-readable medium may further include stored instructions, which when executed by the processor, cause the processor to: handle a second abort triggered after the first abort when the virtual processor executes a data access instruction to access data stored in the first page of the virtual machine memory, the first page of the virtual machine memory having the read and write permissions disabled, the data access instruction being stored in a second page of the virtual machine memory different than the first page, including: reverting the replacement of the one or more instructions in the first page of the virtual machine memory; restoring the read and write permissions on the first page of the virtual machine memory and disabling the execute permission in the first entry of the page table corresponding to the first page of the virtual machine memory; and resuming execution of the guest program on the virtual processor.

The non-transitory computer-readable medium may further include stored instructions, which when executed by the processor, cause the processor to: handle a second abort triggered after the first abort when the virtual processor executes a data access instruction in the first page of the virtual machine memory to access data stored in the first page of the virtual machine memory, the first page of the virtual machine memory having the read and write permissions disabled, including: reverting the replacement of the one or more instructions in the first page of the virtual machine memory; restoring the read and write permissions in the first entry of the page table corresponding to the first page of the virtual machine memory; executing a single step of the execution of the guest program; scanning the first page of the virtual machine memory for the one or more instructions and replacing detected instances of instructions; disabling read and write permissions and enabling the execute permission in the first entry of the page table corresponding to the first page of the virtual machine memory; and resuming the execution of the guest program on the virtual processor.

The replacing may include replacing instances of a first instruction with a breakpoint instruction, and the non-transitory computer-readable medium may further include stored instructions, which when executed by a processor, cause the processor to: emulate behavior of the first instruction in the virtual processor of the virtual machine and modify a program counter of the virtual machine before resuming execution of the guest program on the virtual processor.

The processor may implement a host instruction set architecture and the virtual processor may implement a target instruction set architecture different from the host instruction set architecture, and the first instruction may be supported by the target instruction set architecture and unsupported by the host instruction set architecture.

The processor may implement a host instruction set architecture and the virtual processor may implement a target instruction set architecture different from the host instruction set architecture, and the replacing may include replacing instances of a first instruction of the target instruction set architecture with a functionally equivalent instruction of the host instruction set architecture.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
executing, on a host computer comprising a host processor and host memory, a hypervisor managing a virtual machine comprising a virtual processor and virtual machine memory, the virtual machine executing a guest program stored in the virtual machine memory, the guest program comprising machine instructions;
disabling, by the hypervisor, execute permissions on a first page of the virtual machine memory; and
handling, by the hypervisor, a first abort triggered when the virtual processor executes an instruction in the first page of the virtual machine memory having an execute permission disabled comprising:
replacing, by the hypervisor, one or more instructions in the first page of the virtual machine memory;
disabling read and write permissions and enabling an execute permission in a first entry of a page table corresponding to the first page of the virtual machine memory; and
resuming execution of the guest program on the virtual processor.

2. The method of claim 1, wherein the replacing comprises replacing instances of a first instruction with a breakpoint instruction, and
wherein the method further comprises emulating behavior of the first instruction in the virtual processor of the virtual machine and modifying a program counter of the virtual machine before resuming execution of the guest program on the virtual processor.

3. The method of claim 2, wherein the host processor implements a host instruction set architecture and the virtual processor implements a target instruction set architecture different from the host instruction set architecture, and
wherein the first instruction is supported by the target instruction set architecture and unsupported by the host instruction set architecture.

4. The method of claim 2, wherein the host processor implements a host instruction set architecture and the virtual processor implements a target instruction set architecture different from the host instruction set architecture, and
wherein the first instruction has different behavior in the host instruction set architecture than in the target instruction set architecture.

5. The method of claim 2, wherein the first instruction is a privileged instruction that is not executable by the virtual processor.

6. The method of claim 1, further comprising:
handling a second abort triggered after the first abort when the virtual processor executes a data access instruction to access data in the first page of the virtual machine memory, the first page of virtual machine memory having the read and write permissions disabled, the data access instruction being stored in a second page of the virtual machine memory different than the first page, comprising:
reverting the replacement of the one or more instructions in the first page of the virtual machine memory;
restoring the read and write permissions on the first page of the virtual machine memory and disabling the execute permission in the first entry of the page table corresponding to the first page of the virtual machine memory; and
resuming execution of the guest program on the virtual processor.

7. The method of claim 1, further comprising:
handling a second abort triggered after the first abort when the virtual processor executes a data access instruction in the first page of the virtual machine memory to access data stored in the first page of the virtual machine memory, the first page of the virtual machine memory having the read and write permissions disabled, comprising:
reverting the replacement of the one or more instructions in the first page of the virtual machine memory;
restoring the read and write permissions in the first entry of the page table corresponding to the first page of the virtual machine memory;
executing a single step of the execution of the guest program;
scanning the first page of the virtual machine memory for the one or more instructions and replacing detected instances of instructions;
disabling the read and write permissions in the first entry of the page table corresponding to the first page of the virtual machine memory; and
resuming the execution of the guest program on the virtual processor.

8. The method of claim 1, further comprising:
handling a second abort triggered when the virtual processor executes a data access instruction; and
emulating the data access instruction without changing the permissions in an entry of the page table corresponding to a page of the virtual machine memory associated with the second abort.

9. The method of claim 1, further comprising:
in response to determining that one or more instructions were replaced in the first page of the virtual machine memory, disabling a read permission and a write permission in the first entry of the page table corresponding to the first page of the virtual machine memory; and
in response to determining that no instructions were replaced in the first page of the virtual machine memory, enabling the read permission and disabling the write permission in the first entry of the page table corresponding to the first page of the virtual machine memory.

10. A system comprising:
a host memory storing instructions; and
a host processor, coupled with the host memory and to execute the instructions, the instructions when executed cause the host processor to:
execute a hypervisor managing a virtual machine comprising:
a virtual processor; and
a virtual machine memory,
the virtual processor executing a guest program stored in the virtual machine memory, the guest program comprising machine instructions;
disable execute permissions on a first page of the virtual machine memory; and
handle, by the hypervisor, a first abort triggered when the virtual processor executes an instruction in the first page of the virtual machine memory having an execute permission disabled in a first entry of a page table corresponding to the first page of the virtual machine memory, comprising:
scanning the first page of the virtual machine memory for one or more instructions and replacing detected instances of the one or more instructions;
disabling read and write permission and enabling an execute permission in the first entry of the page table corresponding to the first page of the virtual machine memory; and
resuming execution of the guest program on the virtual processor.

11. The system of claim 10, wherein the host processor comprises a plurality of processor cores,
wherein the virtual processor comprises a plurality of virtual processor cores, and
wherein the instructions to handle the first abort comprise instructions that, when executed by a host processor core of the host processor, cause the host processor core to:
execute an atomic compare and exchange operation on the first entry of the page table corresponding to the first page of the virtual machine memory to disable access permissions before executing the instructions to scan the first page of the virtual machine memory.

12. The system of claim 11, wherein the host memory further stores instructions that, when executed by the host processor, cause the host processor to:
in response to the atomic compare and exchange operation detecting that the access permissions are already disabled, resume execution of the guest program on the virtual processor or suspend execution of the virtual processor.

13. The system of claim 10, wherein the host memory further stores instructions that, when executed by the host processor, cause the host processor to:
handle a second abort triggered after the first abort when a first virtual processor core of the virtual processor executes a data access instruction to access data in the first page of the virtual machine memory, the first page of the virtual machine memory having access permissions disabled by the first virtual processor core comprising:
when the data access instruction is in a second page of the virtual machine memory different from the first page of the virtual machine memory:
reverting the replacement of the one or more instructions in the first page of the virtual machine memory;
restoring the read and write permissions on the first page of the virtual machine memory and disabling the execute permission in the first entry of the page table corresponding to the first page of the virtual machine memory; and
resuming execution of the guest program on the virtual processor; and
when the data access instruction is in the first page of the virtual machine memory:
reverting the replacement of the one or more instructions in the first page of the virtual machine memory;
restoring the read and write permissions in the first entry of the page table corresponding to the first page of the virtual machine memory in a manner visible only to the first virtual processor core;
enabling the execute permission in the first entry of the page table corresponding to the first page of the virtual machine memory in a manner visible only to the first virtual processor core;
executing a single step of the execution of the guest program;
scanning the first page of the virtual machine memory for the one or more instructions in the first page of the virtual machine memory replacing detected instances of instructions;
disabling the read and write permissions and enabling the execute permission in the first entry of the page table corresponding to the first page of the virtual machine memory; and
resuming the execution of the guest program on the virtual processor.

14. The system of claim 13, wherein the host processor comprises a plurality of host processor cores,
wherein the virtual processor comprises a plurality of virtual processor cores, and
wherein the host memory further stores instructions that, when executed by a host processor core of the host processor, cause the host processor core to:
handle a third abort triggered after the first abort when a second virtual processor core of the virtual processor executes a second data access instruction to access data in the first page of the virtual machine memory comprising:
executing an atomic compare and exchange operation on the first entry of the page table corresponding to the first page of the virtual machine memory to disable the access permissions; and
in response to detecting that the first page of the virtual machine memory has access permissions disabled, return control to the second virtual processor core or suspend execution of the second virtual processor core.

15. A non-transitory computer-readable medium comprising stored instructions, which when executed by a processor, cause the processor to:
execute a hypervisor configured to manage a virtual machine comprising:
a virtual processor; and
a virtual machine memory,
the virtual processor executing a guest program stored in the virtual machine memory, the guest program comprising machine instructions;
disable execute permissions on each page of memory associated with the virtual machine memory; and
handle, by the hypervisor, a first abort triggered when the virtual processor executes an instruction in a first page of the virtual machine memory having an execute permission disabled in a first entry of a page table corresponding to the first page of the virtual machine memory, comprising:
scanning the first page of the virtual machine memory for one or more instructions and replacing detected instances of instructions;
disabling read and write permissions and enabling an execute permission in the first entry of the page table corresponding to the first page of the virtual machine memory; and
resuming execution of the guest program on the virtual processor.

16. The non-transitory computer-readable medium of claim 15, further comprising stored instructions, which when executed by the processor, cause the processor to:
handle a second abort triggered after the first abort when the virtual processor executes a data access instruction to access data stored in the first page of the virtual machine memory, the first page of the virtual machine memory having the read and write permissions disabled, the data access instruction being stored in a second page of the virtual machine memory different than the first page, comprising:
reverting the replacement of the one or more instructions in the first page of the virtual machine memory;
restoring the read and write permissions on the first page of the virtual machine memory and disabling the execute permission in the first entry of the page table corresponding to the first page of the virtual machine memory; and
resuming execution of the guest program on the virtual processor.

17. The non-transitory computer-readable medium of claim 15, further comprising stored instructions, which when executed by the processor, cause the processor to:
handle a second abort triggered after the first abort when the virtual processor executes a data access instruction in the first page of the virtual machine memory to access data stored in the first page of the virtual machine memory, the first page of the virtual machine memory having the read and write permissions disabled, comprising:
reverting the replacement of the one or more instructions in the first page of the virtual machine memory;
restoring the read and write permissions in the first entry of the page table corresponding to the first page of the virtual machine memory;
executing a single step of the execution of the guest program;
scanning the first page of the virtual machine memory for the one or more instructions and replacing detected instances of instructions;
disabling read and write permissions and enabling the execute permission in the first entry of the page table corresponding to the first page of the virtual machine memory; and
resuming the execution of the guest program on the virtual processor.

18. The non-transitory computer-readable medium of claim 15, wherein replacing comprises replacing instances of a first instruction with a breakpoint instruction, and
wherein the non-transitory computer-readable medium further comprises stored instructions, which when executed by a processor, cause the processor to:
emulate behavior of the first instruction in the virtual processor of the virtual machine and modify a program counter of the virtual machine before resuming execution of the guest program on the virtual processor.

19. The non-transitory computer-readable medium of claim 18, wherein the processor implements a host instruction set architecture and the virtual processor implements a target instruction set architecture different from the host instruction set architecture, and
wherein the first instruction is supported by the target instruction set architecture and unsupported by the host instruction set architecture.

20. The non-transitory computer-readable medium of claim 15, wherein the processor implements a host instruction set architecture and the virtual processor implements a target instruction set architecture different from the host instruction set architecture, and
wherein the replacing comprises replacing instances of a first instruction of the target instruction set architecture with a functionally equivalent instruction of the host instruction set architecture.
